(19) United States
(12) Patent Application Publication
(10) Pub. No.: US 2026/0084165 A1
(43) Pub. Date: Mar. 26, 2026

(54) COATING DEVICE AND COATING METHOD

(71) Applicant: TAIKISHA LTD., Tokyo (JP)

(72) Inventors: Keiji MANABE, Tokyo (JP); Shogo NODA, Tokyo (JP); Yukiya TAKIZAWA, Tokyo (JP); Ryuto AKAOGI, Tokyo (JP); Tatsuya TANIKAWA, Aichi (JP); Yohei SATO, Aichi (JP); Aoi OKAMURA, Aichi (JP)

(73) Assignee: TAIKISHA LTD., Tokyo (JP)

(21) Appl. No.: 19/137,568

(22) PCT Filed: Nov. 6, 2023
(86) PCT No.: PCT/JP2023/039871

§ 371 Date: Jun. 10, 2025

(30) Foreign Application Priority Data
Dec. 15, 2022 (JP) 2022-200228

(51) Int. Cl. B05B 5/053; B05B 5/08

(52) U.S. Cl. CPC B05B 5/053; B05B 5/08

(57) ABSTRACT

A coating device for atomizing a paint having an electrical resistivity of 20 MΩ·cm or less using an action of an electric field, and includes a nozzle to which a voltage is applied, a flow passage along which the paint flows, a measuring unit that measures a supplied current, and a controller that controls the voltage applied to the nozzle, based on a measurement value of the measuring unit.

### TECHNICAL FIELD

The present invention relates to a coating device and a coating method.

### BACKGROUND ART

Electrostatic atomization coating is a coating method in which paint is turned into fine droplets by the action of an electric field which is formed between an electrically charged nozzle and a conductor arranged opposing the nozzle, and the fine droplets are then sprayed onto a coating target.

For example, JP 2018-008253A (Patent Document 1) discloses an electrostatic spraying device used when performing coating using an electrostatic coating method. According to the electrostatic spraying device of Patent Document 1, it is possible to reduce variation in the amount of liquid spray ed from the nozzles, regardless of the spray direction of the liquid.

In order to achieve uniform coating with electrostatic atomization coating, it is effective to make the particle size of the paint particles uniform, and in order to do this, it is necessary to control the nozzles such that the electric field formed between the nozzles and the conductor is uniform. Since the strength of the electric field is a function of the distance between the positive and negative electrodes and the applied voltage, the strength of the electric field can be kept constant by controlling the voltage applied to the nozzles according to the distance between the nozzles and the conductor. Typically, the nozzles attached to the leading end of an industrial robot are moved along a pre-set path conforming to the shape of the coating target, and the voltage applied to the nozzles is controlled according to the distance between the nozzles and the conductor at points on the path, thereby making the particle size of the paint uniform.

### PRIOR ART DOCUMENT

### Patent Document

Patent Document 1: JP 2018-008253A

### DISCLOSURE OF THE INVENTION

### Problem to be Solved by the Invention

However, if the coating target and the conductor are not at intended positions, deviation from the above-described control will occur. For example, if the coating target and conductor are located farther along the nozzle path than the intended positions, a voltage that is lower in proportion to the distance between the nozzles and the conductor will be applied, thus resulting in an electric field with a strength that is lower than intended. In other words, deviation in the positions of the coating target and the conductor can hinder the uniformity of the particle size of the paint, which can ultimately lead to a deterioration in coating quality.

In view of this, there is a desire to realize a coating device and a coating method in which deviation in the positions of the coating target and the conductor is less likely to affect the coating quality.

### Means for Solving Problem

A coating device according to an aspect of the present invention is a coating device configured to atomize a paint having an electrical resistivity of 20 MΩ·cm or less using an action of an electric field, including: a nozzle to which a voltage is applied; a flow passage along which the paint is flowable; a measuring unit configured to measure a supplied current; and a controller configured to control the voltage applied to the nozzle, based on a measurement value of the measuring unit.

A coating method according to an aspect of the present invention is a coating method for atomizing a paint having an electrical resistivity of 20 MΩ·cm or less by an action of an electric field, including the steps of: measuring a supplied current; and controlling a voltage applied to a nozzle that discharges the paint, based on a measurement value of the current.

According to these configurations, by measuring the current and controlling the voltage based on the current, it is possible to suppress non-uniformity in the electric field caused by deviation in the relative positional relationship between the nozzle and a conductor. Therefore, deviation in the positions of the coating target and the conductor is less likely to affect the coating quality.

Further features and advantages of the present invention will become more apparent from the following description of exemplary and non-limiting embodiments, which are given with reference to the drawings.

### BRIEF DESCRIPTION OF THE DRAWINGS

FIG. 1 is a cross-sectional view of a coating device according to a first embodiment.

FIG. 2 is a block diagram showing constituent components of the coating device according to the first embodiment.

FIG. 3 is a schematic diagram showing usage of the coating device according to the first embodiment.

FIG. 4 is a cross-sectional view of a coating device according to a second embodiment.

FIG. 5 is a cross-sectional view of a coating device according to a third embodiment.

FIG. 6 is a block diagram showing constituent components of the coating device according to the third embodiment.

### BEST MODE FOR CARRYING OUT THE INVENTION

Embodiments of a coating device and a coating method according to the present invention will be described below with reference to the drawings.

### First Embodiment

In the following, an example will be described in which a coating device according to the present invention is applied to a coating device 1A for electrostatic atomization coating, and to a coating method using the same.

### Configuration of Coating Device

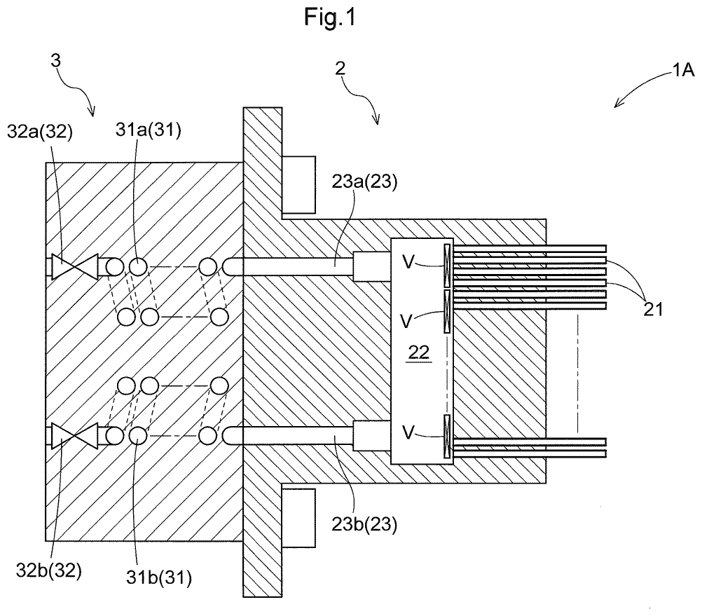

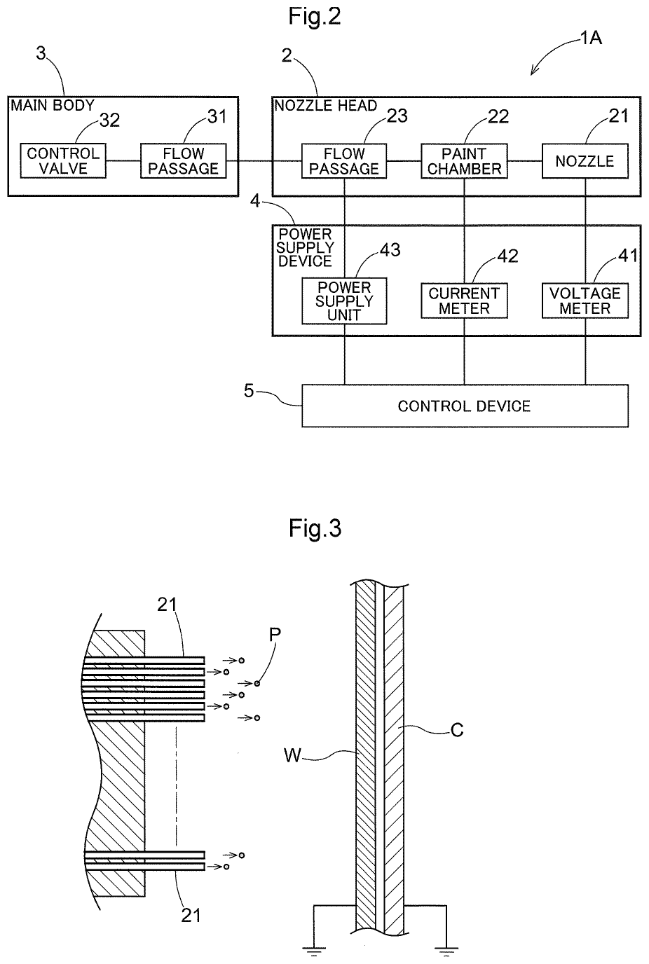

The coating device 1 A according to a first embodiment includes a nozzle head 2, a main body 3 connected to a working arm of a coating robot (not shown), a power supply device 4, and a control device 5 (an example of a controller) (FIGS. 1 and 2).

The nozzle head 2 includes nozzles 21 to which a voltage is applied, a paint chamber 22 to which the base ends of the nozzles 21 are connected, and flow passages 23 (23a, 23b) that are in communication with a paint supply source (not shown) via the main body 3. A plurality of nozzles 21 are provided, and in the present embodiment, the nozzles 21 are arranged in a straight line. The paint chamber 22 is a member that serves to distribute a paint supplied from a paint supply source to the nozzles 21, and in the present embodiment, is provided as a substantially rectangular parallelepiped space. Two flow passages 23 are provided, one being a flow passage 23a that is part of the flow passage of paint supplied from the paint supply source to the paint chamber 22 (hereinafter sometimes referred to as the “outgoing passage”), and the other flow passage 23b being part of the flow passage of paint returning from the paint chamber 22 to the paint supply source (hereinafter sometimes referred to as the “return passage”). Note that in addition to the above, the nozzle head 2 can also include other constituent components such as on-off valve devices V that open and close the nozzles 21.

The voltage applied to the nozzles 21 depends on the output of the power supply device 4. The output of the power supply device is controlled by the control device 5. Note that except for the path electrically connecting the nozzles 21 to the power supply device 4, the constituent components of the coating device 1A are designed to be electrically insulated, and are at least not actively configured to be electrically conductive.

The main body 3 has flow passages 31 (31a, 31b) that connect the nozzle head 2 to the paint supply source (not shown), and control valves 32 (32a, 32b) that control the flow of the paint in the flow passages 31 (31a, 31b). Among the flow passages 31 and the control valves 32, the flow passage 31 a and the control valve 32a are the outgoing passage for the paint, similarly to the flow passage 23a of the nozzle head 2, and the flow passage 31b and the control valve 32b are the return passage for the paint, similarly to the flow passage 23b of the nozzle head 2. Thus, the control valve 32a controls the flow of the paint supplied to the paint chamber 22, and the control valve 32b controls the flow of the paint returned to the paint supply source. Note that the operation of the control valves 32 (32a, 32b) is controlled by the control device 5.

The flow passages 31 (31a, 31b) are provided in a spiral shape. Therefore, the length of the flow passages 31 (31 a, 31b) is longer than in the case where the base end side and the leading end side of the main body 3 are connected with a straight line. Note that the base end side of the main body 3 refers to the side that is connected to the working arm of a coating robot (not shown), and is the side that is located on the lower side of the paper in FIG. 1. Moreover, the leading end side of the main body 3 refers to the side connected to the nozzle head 2, and is the side located on the upper side in FIG. 1.

As a material for forming the flow passages 23 (23a, 23b) and the flow passages 31 (31a, 31b), a resin material is preferable from the viewpoint of using a material that has excellent electrical insulating properties. Examples of such resin materials include fluoro-resins and nylon resins, but are not limited to these examples. Note that the materials forming the flow passage 23a, the flow passage 23b, the flow passage 31a, and the flow passage 31b can be selected independently.

A known power supply device can be used as the power supply device 4. The power supply device 4 can measure measurement values related to the operating state thereof and input the measurement values to the control device 5. Specifically, the power supply device 4 includes a voltage meter 41 that measures the voltage applied to the nozzle head 2 (nozzles 21), a current meter 42 (an example of a measuring unit) that measures the current flowing through the nozzle head 2, and a power supply unit 43 that supplies a voltage to the nozzle head 2 (FIG. 2).

The control device 5 may be a known control device such as a computer. The control device controls the output of the power supply device 4 (the voltage applied to the nozzles 21) based on the measurement value of the current meter 42. Note that the control device 5 may have other functions, such as controlling the coating robot.

### Coating Principle and Coating Control

The coating device 1A is a coating device that atomizes a paint by the action of an electric field formed between the nozzles 21 that eject the paint and a conductor C arranged opposing the nozzles 21 (FIG. 3). An electric field is formed between the nozzles 21, to which a voltage is being applied, and the conductor C, which is connected to ground, and the paint becomes charged with the same polarity as the nozzles 21, causing the paint to be attracted to the conductor C. Also, since paint droplets P leaving the nozzles 21 are electrically charged, a repulsive force is generated between the droplets P, preventing them from coalescing, and thus fine droplets P are realized.

The paint, which is in the form of the fine droplets P, flies due to being attracted to the conductor C by the action of the electric field, and adheres to a coating target W. The coating target W is connected to ground, and the charge carried by the paint droplets P flows to the earth through a ground point of the coating target W. Through the above operation, a current flows between the nozzles 21 and the coating target W, using the droplets Pas a medium. In other words, if the coating device 1 A is controlled such that the magnitude of the current flowing between the nozzles 21 and the coating target W is constant, it can be expected that the size, the discharge speed, and the like of the formed paint droplets P will be constant. This contributes to stabilizing the coating quality. Therefore, it is necessary to specify the magnitude of the current flowing between the nozzles 21 and the coating target W.

As described above, except for the path electrically connecting the nozzles 21 to the power supply device 4, the components of the coating device 1A are designed to be electrically insulated. Therefore, at least in terms of design, the current supplied to the coating device 1A matches the current flowing between the nozzles 21 and the coating target W using the droplets P as a medium. However, a current (hereinafter referred to as leakage current) can possibly flow to the paint supply source via the paint circuit(flow passages 23, flow passages 31), as an unintended current. In other words, the current flowing between the nozzles 21 and the coating target W is obtained by subtracting the leakage current from the measurement value of the current meter 42, and therefore in order to correctly identify the current flowing between the nozzles 21 and the coating target W, it is necessary to specify the leakage current.

In the present embodiment, instead of specifying the leakage current, the leakage current is suppressed to a negligible level, and therefore the measurement value of the current meter 42 can be treated as being the same as the current flowing between the nozzles 21 and the coating target W. Specifically, by forming the flow passages 31 (31a, 31b) in a spiral shape and with a longer length, the resistance of the paint circuit is increased, and as a result, the ground resistance of the nozzles 21 becomes 25 GΩ or more, and the leakage current is thus suppressed to a negligible level. Therefore, in the present embodiment, the measurement value of the current meter 42 indicates the current flowing between the nozzles 21 and the coating target W, and by controlling the output of the power supply device 4 such that this measurement value is constant, the size, the discharge speed, and the like of the paint droplets P can be kept constant.

Note that in the above description, the coating target W is an electrically insulated body, but the coating target can also possibly be an electrically conductive body. In the case where the coating target W is an electrically conductive body, the coating target W itself plays a role in forming an electric field with the nozzles 21, and therefore there is no need to provide the separate electrical conductor C. This also similarly applies to the embodiments described below.

### Second Embodiment

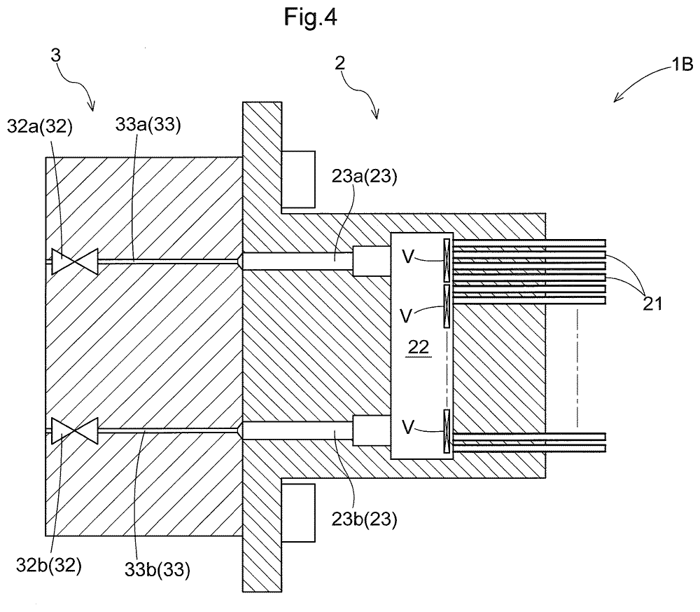

In a coating device 1B according to a second embodiment, straight flow passages 33 (33a, 33b) are provided instead of the flow passages 31 (31a, 31b) in the first embodiment (FIG. 4). However, the inner diameter of the flow passages 33 (33a, 33b) is 0.8 mm or more and 1.0 mm or less, which is narrower than the tubes used as paint flow passages in this type of the coating device. By making the flow passages 33 (33a, 33b) narrower, the resistance of the paint circuit is increased, and as a result, the ground resistance of the nozzles 21 becomes 25 GΩ or more, and therefore the leakage current is suppressed to a negligible level as in the first embodiment.

When the inner diameter of the flow passages 33 (33a, 33b) is 1 mm or less, the ground resistance of the nozzles 21 tends to be sufficiently large, thus making it easy to suppress leakage current. On the other hand, if the inner diameter of the flow passages 33 (33a, 33b) is 1 mm or more, the paint is more likely to be smoothly supplied to the nozzles 21.

Note that the other constituent components are similar to those in the first embodiment.

### Third Embodiment

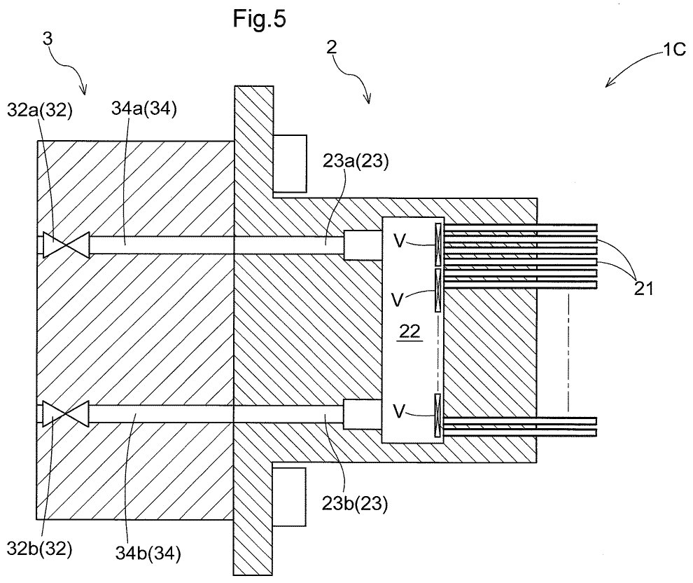

In a coating device 1C according to a third embodiment, straight flow passages 34 (34a, 34b) (FIG. 5)are provided instead of the flow passages 31 (31a, 31b) in the first embodiment. The flow passages 34 (34a, 34b) have dimensions that are generally used as paint flow passages in this type of the coating device. Therefore, in the third embodiment, it is difficult to expect the effect of suppressing leakage current to a negligible level as seen in the first and second embodiments.

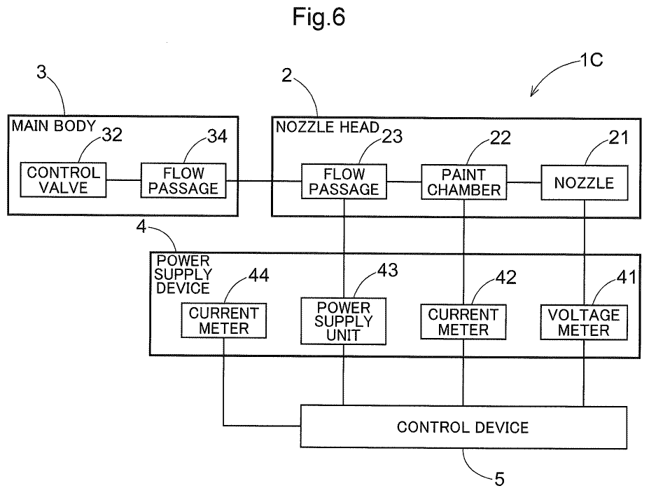

Therefore, in the third embodiment, in addition to the current meter 42 provided as in the first and second embodiments, a second current meter 44 (an example of a measuring unit) (FIG. 6) is provided to measure the current (leakage current) flowing through the flow passages 34. Specifically, by subtracting the measurement value of the current meter 44, which indicates the leakage current, from the measurement value of the current meter 42, which indicates the total amount of current supplied to the nozzle head 2, it is possible to specify the current flowing between the nozzles 21 and the coating target W. Therefore, by controlling the output of the power supply device 4 such that the difference between the measurement value of the current meter 42 and the measurement value of the current meter 44 is constant, the size, the discharge speed, and the like of the paint droplets P can be made constant.

Note that the other constituent components are similar to those in the first embodiment.

### Other Embodiments

Lastly, other embodiments of the coating device according to the present invention will be described below. Note that the configurations disclosed in each of the following embodiments can also be applied in combination with configurations disclosed in other embodiments, as long as no contradiction arises.

In particular, the first, second and third embodiments described above can be combined as long as no contradiction arises. For example, a configuration can be adopted in which the flow passages have a spiral shape and have an inner diameter of 1.6 mm or more and 2.0 mm or less. This example combination is similar to the second embodiment in the use of tubes that are narrower than the tubes used as the paint flow passages in the same type of the coating device, but wider tubes than those in the second embodiment can be used. This is because using relatively narrow tubes and giving the flow passages a spiral shape both contribute to increasing the resistance of the paint circuit, and therefore the contribution required from using narrow tubes is smaller than in the second embodiment. Similarly, since the contribution required from having a spiral shape is smaller than in the first embodiment, the number of turns in the spiral shape may be fewer than in the first embodiment. Also, a configuration can also be adopted in which, for example, the flow passages have a spiral shape and the measuring unit measures the current flowing through the flow passages.

In the above embodiments, configurations have been described as an example in which the nozzles 21 are arranged in a straight line. However, in the present invention, there are no limitations on the arrangement of the nozzles. For example, the nozzles may be arranged along the circumference of a circle.

Regarding such other configurations as well, it should be understood that the embodiments disclosed in this specification are illustrative in all respects and that the scope of the present invention is not limited thereto. Those skilled in the art will easily understand that appropriate modifications can be made without departing from the spirit of the present invention. Therefore, other embodiments that are modified without departing from the spirit of the present invention are naturally included in the scope of the present invention.

### DESCRIPTION OF REFERENCE SIGNS

1A Coating device (first embodiment)
2 Nozzle head
21 Nozzle
22 Paint chamber
23 Flow passage
3 Main body
31 Flow passage
32 Control valve
4 Power supply device
41 Voltage meter
42 Current meter
43 Power supply unit
5 Control device
P Droplet
C Conductor
W Coating target
1B Coating device (second embodiment)
33 Flow passage
1C Coating device (third embodiment)
34 Flow passage
44 Current meter

1. A coating device configured to atomize paint having an electrical resistivity of 20 MΩ·cm or less using an action of an electric field, comprising:
a nozzle to which a voltage is applied;
a flow passage along which the paint is flowable;
a measuring unit configured to measure a supplied current; and
a controller configured to control the voltage applied to the nozzle, based on a measurement value of the measuring unit.

2. The coating device according to claim 1,
wherein the flow passage has at least a portion having a spiral shape.

3. The coating device according to claim 1,
wherein the flow passage has at least a portion with an inner diameter of 0.8 mm or more and 1.0 mm or less.

4. The coating device according to claim 2,
wherein the nozzle has a ground resistance of 25 GΩ or more.

5. The coating device according to claim 1,
wherein the measuring unit is further configured to measure a current flowing in the flow passage.

6. A coating method for atomizing paint having an electrical resistivity of 20 MΩ·cm or less using an action of an electric field, comprising the steps of:
measuring a supplied current; and
controlling a voltage applied to a nozzle that discharges the paint, based on a measurement value of the current.

7. The coating device according to claim 3,
wherein the nozzle has a ground resistance of 25 GΩ or more.
